(19) United States
(12) Patent Application Publication
(10) Pub. No.: US 2023/0186877 A1
(43) Pub. Date: Jun. 15, 2023

(54) MUSICAL PIECE STRUCTURE ANALYSIS DEVICE AND MUSICAL PIECE STRUCTURE ANALYSIS METHOD

(71) Applicant: Yamaha Corporation, Hamamatsu (JP)

(72) Inventor: Kouhei SUMI, Hamamatsu (JP)

(21) Appl. No.: 18/164,575

(22) Filed: Feb. 4, 2023

Related U.S. Application Data
(63) Continuation of application No. PCT/JP2021/027379, filed on Jul. 21, 2021.

(30) Foreign Application Priority Data
Aug. 17, 2020 (JP) 2020-137552

(51) Int. Cl. G10H 1/00

(52) U.S. Cl. CPC G10H 1/0008; G10H 2210/036; G10H 2210/051; G10H 2210/056; G10H 2250/135

(57) ABSTRACT

A musical piece structure analysis method includes acquiring an acoustic signal of a musical piece, extracting a first feature amount indicating changes in tone from the acoustic signal of the musical piece, extracting a second feature amount indicating changes in chords from the acoustic signal of the musical piece, outputting a first boundary likelihood indicating likelihood of a constituent boundary of the musical piece from the first feature amount using a first learning model, outputting a second boundary likelihood indicating likelihood of the constituent boundary of the musical piece from the second feature amount using a second learning model, identifying the constituent boundary of the musical piece by performing weighted synthesis of the first boundary likelihood and the second boundary likelihood, and dividing the acoustic signal of the musical piece into a plurality of sections at the constituent boundary that has been identified.

### CROSS-REFERENCE TO RELATED APPLICATIONS

This application is a continuation application of International Application No. PCT/JP2021/027379, filed on Jul. 21, 2021, which claims priority to Japanese Patent Application No. 2020-137552 filed in Japan on Aug. 17, 2020. The entire disclosures of International Application No. PCT/JP2021/027379 and Japanese Patent Application No. 2020-137552 are hereby incorporated herein by reference.

### BACKGROUND

### Technical Field

The present disclosure relates to a musical piece structure analysis device and musical piece structure analysis method for analyzing the structure of a musical piece.

### Background Information

In order to facilitate regeneration or performance of specific sections of a musical piece, analysis of the general structure of a musical piece, such as intro (intro), A melody (verse), B melody (bridge), chorus (chorus), or outro (outro), is carried out. For example, JP 2020-516004 A describes a method for determining highlight segments of the sound source by utilizing a neural network that learns the relationship between a plurality of sound sources and the classification information of each sound source.

In the method described in JP 2020-516004 A, a sound source is divided into a plurality of segments by a neural network processing unit, and segment-specific feature values are extracted for each segment. Also, by using an attention model that calculates the weighted sum of the segment-specific feature values, weighted value information indicating the degree to which each segment contributes to classification information estimation of the sound source is acquired by the neural network processing unit. Important segments are determined by the weighted value information for each sound source segment, and highlight segments are determined based on the important segments thus determined.

### SUMMARY

In order to precisely analyze the beats or chords of a musical piece, more easily analyzing of the general structure of the musical piece is needed.

An object of the present disclosure is to provide a musical piece structure analysis device and musical piece structure analysis method for facilitating analysis of musical piece structure.

A musical piece structure analysis method according to one aspect of the present disclosure is executed by a computer and comprises acquiring an acoustic signal of a musical piece, extracting a first feature amount indicating changes in tone from the acoustic signal of the musical piece, extracting a second feature amount indicating changes in chords from the acoustic signal of the musical piece, outputting a first boundary likelihood indicating likelihood of a constituent boundary of the musical piece from the first feature amount using a first learning model, outputting a second boundary likelihood indicating likelihood of the constituent boundary of the musical piece from the second feature amount using a second learning model, identifying the constituent boundary of the musical piece by performing weighted synthesis of the first boundary likelihood and the second boundary likelihood, and dividing the acoustic signal of the musical piece into a plurality of sections at the constituent boundary that has been identified.

A musical piece structure analysis method according to another aspect of the present disclosure is executed by a computer and comprises acquiring an acoustic signal of a musical piece, dividing the acoustic signal of the musical piece into a plurality of sections, classifying the plurality of sections into clusters based on similarity, and estimating a section qualifying as a specific constituent type portion of the musical piece from the plurality of sections based on result of the classifying of the plurality of the sections.

A musical piece structure analysis method according to yet another aspect of the present disclosure is executed by a computer and comprises acquiring a divided acoustic signal of a musical piece that has been divided into a plurality of sections, classifying the plurality of sections into clusters based on similarity, and estimating a section qualifying as a chorus of the musical piece from the plurality of sections based on a counted number of one or more sections belonging to each of the clusters.

A musical piece structure analysis method according to yet another aspect of the present disclosure is executed by a computer and comprises acquiring a divided acoustic signal of a musical piece that has been divided into a plurality of sections, calculating a score for each of the plurality of section of the divided acoustic signal of the musical piece, based on at least one of similarity of a starting chord or an ending chord in each of the plurality of sections to a tonic chord of a key, or a likelihood of vocals being included in each of the plurality of sections, or both, and estimating a section qualifying as a specific constituent type portion of the musical piece from the plurality of sections based on the score that has been calculated for each of the plurality of sections.

### BRIEF DESCRIPTION OF THE DRAWINGS

FIG. 1 is a block diagram showing the configuration of a musical piece analysis system, including a musical piece structure analysis device according to one embodiment of the present disclosure.

FIG. 2 is a block diagram showing the configuration of the musical piece structure analysis device.

FIG. 3 is a block diagram showing one example of first and second learning models.

FIG. 4 shows a display example on a display unit by a division result output unit.

FIG. 5 illustrates determination of similarity using a maximum value search method.

FIG. 6 shows a display example on a display unit by a classification result output unit.

FIG. 7 is a block diagram showing an example of a third learning model.

FIG. 8 is a flowchart showing an example of a musical piece structure analysis process using the musical piece structure analysis device in FIG. 2.

FIG. 9 is a flowchart showing an example of the musical piece structure analysis process using the musical piece structure analysis device in FIG. 2.

FIG. 10 shows evaluation results of embodiment 1 and comparison examples 1 and 2.

FIG. 11 shows evaluation results of embodiment 2 and comparison examples 3 and 4.

FIG. 12 shows evaluation results of embodiment 3 and comparison examples 5 and 6.

FIG. 13 shows evaluation results of embodiments 4 to 7.

### DETAILED DESCRIPTION OF THE EMBODIMENTS

A musical piece structure analysis device according to embodiments of the present disclosure is described below in detail with reference to the drawings. It will be apparent to those skilled from this disclosure that the following descriptions of the embodiments are provided for illustration only and not for the purpose of limiting the invention as defined by the appended claims and their equivalents.

### Musical Piece Structure Analysis System

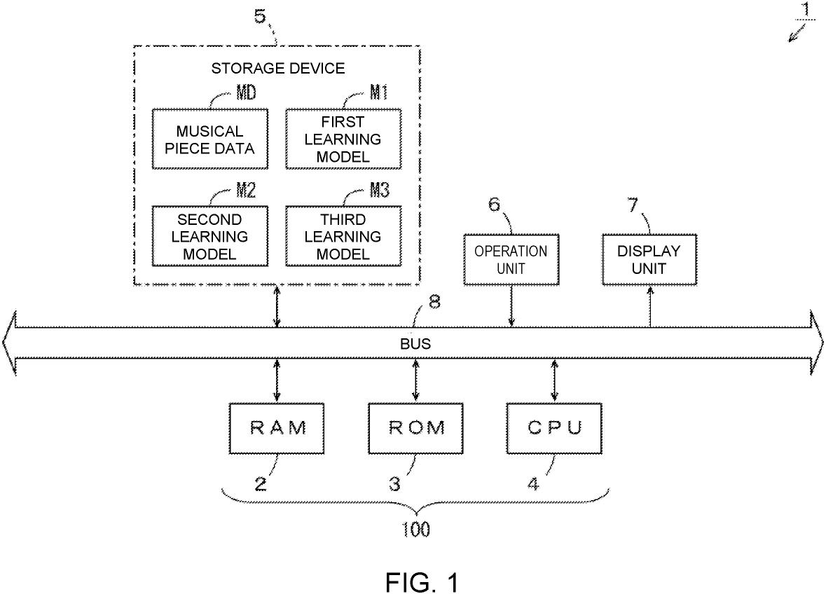

FIG. 1 is a block diagram showing the configuration of a musical piece analysis system, including a musical piece structure analysis device according to one embodiment of the present disclosure. As shown in FIG. 1, a musical piece structure analysis system 1 is provided with a RAM (random access memory) 2, a ROM (read only memory) 3, a CPU (central processing unit) 4, a storage device 5, an operation unit 6, and a display unit 7. The RAM 2, the ROM 3, the CPU 4, the storage device 5, the operation unit 6, and the display unit 7 are connected to a bus 8.

The RAM 2 comprises volatile memory, for example, and is used as a working area for the CPU 4, temporarily storing various types of data. The ROM 3 comprises non-volatile memory, for example, and stores a musical piece structure analysis program for executing a musical piece structure analysis process. The CPU 4 carries out the musical piece structure analysis process by executing in the RAM 2 the musical piece structure analysis program stored in the ROM 3. The musical piece structure analysis process will be described in detail below.

The storage device 5 is a memory (computer memory) and includes a storage medium such as a hard disk, an optical disc, a magnetic disc, or a memory card, and stores one or more musical piece data MD. The musical piece data MD include acoustic signals (audio signals) of a musical piece. The storage device 5 can store the musical piece structure analysis program instead of the ROM 3. Further, the storage device 5 stores a first learning model M1, a second learning model M2, and a third learning model M3, which are generated in advance by machine learning.

The musical piece structure analysis program can be provided in a form stored in a computer-readable storage medium and installed in a memory (computer memory) such as the ROM 3 or the storage device 5. Furthermore, if the musical piece structure analysis system 1 is connected to a communication network, the musical piece structure analysis program distributed from a server connected to the communication network can be installed in the ROM 3 or the storage device 5. A musical piece structure analysis device 100 is configured by the RAM 2, the ROM 3, and the CPU 4. The RAM 2 and the ROM 3 are examples of memory (computer memory) of the musical piece structure analysis device 100. The CPU 4 is one example of at least one processor as an electronic controller of the musical piece structure analysis device 100. Here, the term “electronic controller” as used herein refers to hardware, and does not include a human. The musical piece structure analysis device 100 includes, instead of the CPU 4 or in addition to the CPU 4, one or more types of processors, such as a GPU (Graphics Processing Unit), a DSP (Digital Signal Processor), an FPGA (Field Programmable Gate Array), an ASIC (Application Specific Integrated Circuit), and the like. As discussed later, the CPU 4 is configured to execute a plurality of units included in the section division unit 10, the section classification unit 20, and the constituent type estimation unit 30.

The operation unit 6 is a user operable input and includes a mouse or other pointing device, or a keyboard and is operated by the user in order to carry out prescribed selections or designations. The display unit 7 is a display and includes, for example, a liquid-crystal display and displays the results of the musical piece structure analysis process. The operation unit 6 and the display unit 7 can be configured by a touch panel display.

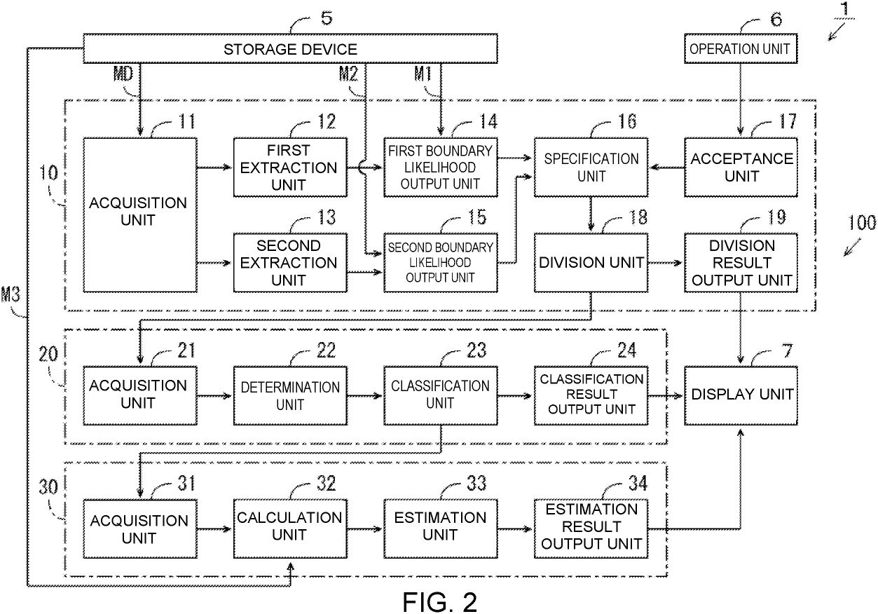

FIG. 2 is a block diagram showing the configuration of the musical piece structure analysis device 100. As shown in FIG. 2, the musical piece structure analysis device 100 includes a section division unit 10, a section classification unit 20, and a constituent type estimation unit 30. Functions of the section division unit 10, the section classification unit 20, and the constituent type estimation unit 30 can be realized by the CPU 4 in FIG. 1, which executes the musical piece structure analysis program. Some or all of the section division unit 10, the section classification unit 20, and the constituent type estimation unit 30 can be realized in hardware such as electronic circuits.

The section division unit 10 identifies one or more constituent boundaries of an acoustic signal of a musical piece and divides the acoustic signal into a plurality of sections at the one or more identified constituent boundaries. The section classification unit 20 classifies the plurality of sections obtained by the dividing at the section division unit 10 into clusters based on similarity (degree of similarity). Classifying sections into clusters is hereinafter referred to as clustering. The constituent type estimation unit 30 estimates one or more sections qualifying as (corresponding to) a specific constituent type portion in the musical piece from sections clustered by the section classification unit 20. The section division unit 10, the section classification unit 20, and the constituent type estimation unit 30 are described in detail below.

### Section Division Unit

As shown in FIG. 2, the section division unit 10 includes an acquisition unit 11, a first extraction unit 12, a second extraction unit 13, a first boundary likelihood output unit 14, a second boundary likelihood output unit 15, an identification unit 16, an acceptance unit 17, a division unit 18, and a division result output unit 19. The acquisition unit 11 acquires the musical piece data MD selected by the user from among the musical piece data MD stored in the storage device 5. The user can select the desired musical piece data MD by operating the operation unit 6.

The first extraction unit 12 extracts a first feature amount indicating changes in tone from the acoustic signal of the musical piece data MD acquired by the acquisition unit 11. The first feature amount is, for example, a mel scale log spectrum (MSLS). The complex spectrum is obtained by performing discrete Fourier transform on the acoustic signal for each beat. The MSLS is extracted by calculating the logarithm of the filter bank energies obtained by applying a mel scale filter bank to the absolute value of the complex spectrum. In the present embodiment, the MSLS is an 80-dimension vector.

The second extraction unit 13 extracts a second feature amount indicating changes in chords from the acoustic signal of the musical piece data MD acquired by the acquisition unit 11. The second feature amount is a chroma vector, for example. In the high-frequency region, a part of the chroma vector is extracted by arranging 12 values and the value of the intensity of the acoustic signal. The 12 values are obtained by adding over a plurality of octaves the intensities of frequency components corresponding to the 12 tempered half-steps which are included in the acoustic signal on each beat. Furthermore, the remaining portion of the chroma vector is extracted by carrying out a similar process in the low-frequency region. Accordingly, in the present embodiment, the chroma vector is a 26-dimensional vector.

The first boundary likelihood output unit 14 outputs for each beat the first boundary likelihood indicating the likelihood of a constituent boundary of the musical piece, by inputting the first feature amount extracted by the first extraction unit 12 into the first learning model M1 stored in the storage device 5. The second boundary likelihood output unit 15 outputs for each beat the second boundary likelihood indicating the likelihood of the constituent boundary of the musical piece, by inputting the second feature amount extracted by the second extraction unit 13 into the second learning model M2 stored in the storage device 5.

The identification unit 16 identifies one or more constituent boundaries of the musical piece by performing weighted synthesis of the first and second boundary likelihoods output by the first and second boundary likelihood output units 14, 15, respectively, for each beat. In the present embodiment, one or more beats for which the value that has been synthesized by weighting is greater than or equal to a prescribed threshold value are identified as being one or more constituent boundaries of the musical piece. The weighting coefficient can be a predetermined constant value or a variable value.

The acceptance unit 17 accepts the designation of the weighting coefficient from the operation unit 6. The user can designate the weighting coefficient by operating the operation unit 6. If the weighting coefficient is a predetermined constant value, the section division unit 10 need not include the acceptance unit 17. If the weighting coefficient is accepted using the acceptance unit 17, the identification unit 16 performs weighted synthesis of the first and second boundary likelihoods based on the accepted weighting coefficient.

The division unit 18 divides the acoustic signal of the musical piece into a plurality of sections at the one or more constituent boundaries identified by the identification unit 16. Further, the division unit 18 sends the acoustic signal which has been divided into a plurality of sections to the section classification unit 20. The division result output unit 19 displays in a viewable manner in the display unit 7 the section division results by the division unit 18. If the section division results need not be displayed in the display unit 7, the section division unit 10 need not include the division result output unit 19.

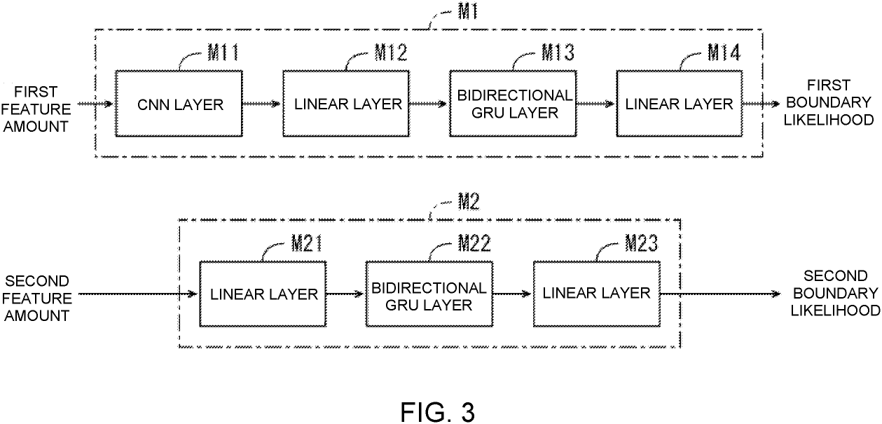

FIG. 3 is a block diagram showing an example of the first and second learning models M1, M2. As shown in FIG. 3, in the present embodiment, a convolutional neural network (CNN) layer M11, a linear layer M12, a bidirectional gated recurrent unit (GRU) layer M13 and a linear layer M14 are arranged in the first learning model M1 in this order from input to output. In the second learning model M2, a linear layer M21, a bidirectional GRU layer M22, and a linear layer M23 are arranged in this order from input to output.

A plurality of pieces of musical piece data for learning to which labels indicating constituent boundaries of the musical pieces have been applied are provided ahead of time as learning data. In each learning data, the label “1” is assigned to sections corresponding to beats which are constituent boundaries, and the label “0” is assigned to sections corresponding to beats which are not constituent boundaries. The first learning model M1 for outputting the first boundary likelihood is generated by performing deep learning using the first feature amount extracted from many learning data. Similarly, the second learning model M2 for outputting the second boundary likelihood is generated by performing deep learning using the second feature amount extracted from a large amount of learning data.

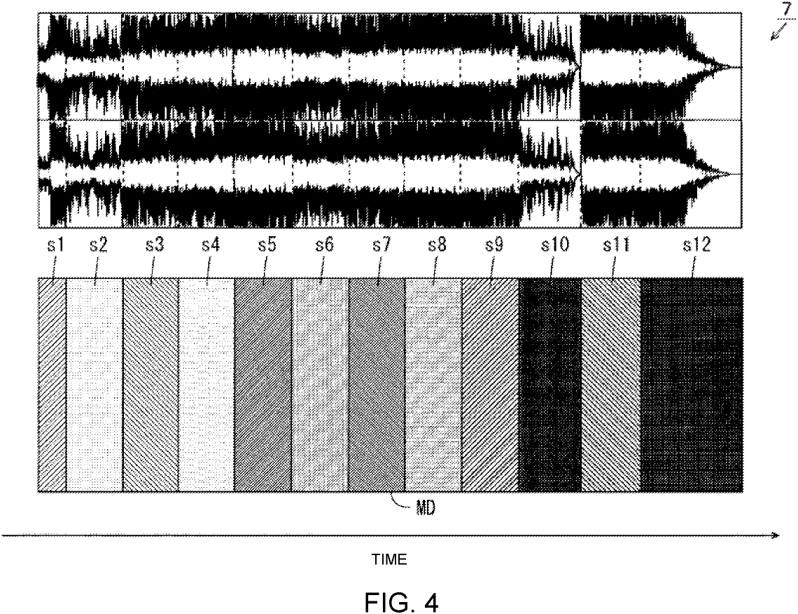

FIG. 4 shows a display example by the division result output unit 19 on the display unit 7. As shown in FIG. 4, the section division results from the division unit 18 are displayed on the display unit 7 by the division result output unit 19 as the results of the musical piece structure analysis processing. In the display example in FIG. 4, the musical piece data MD is indicated by band-like indicators extending in the direction of the time axis (the horizontal direction in this example). Further, the waveform of the acoustic signal to be analyzed is shown above the indicators of the musical piece data MD. Note that the waveform of the acoustic signal can be displayed below the indicators or displayed overlapping the indicators. Alternately, the waveform of the acoustic signal can also be displayed in another manner that can present the relation to the indicators. The musical piece data MD is divided into a plurality of sections s1 to s12 at the constituent boundaries identified by the identification unit 16. The sections s1 to s12 are indicated by rectangular indicators with unique colors. The user can easily identify the constituent boundaries of the musical piece by viewing the display unit 7.

### Section Classification Unit

As shown in FIG. 2, the section classification unit 20 includes an acquisition unit 21, a determination unit 22, a classification unit 23, and a classification result output unit 24. The acquisition unit 21 acquires the acoustic signal (divided acoustic signal) of the musical piece which has been divided into the plurality of sections from the section division unit 10. The determination unit 22 determines similarity (degree of similarity) of the plurality of sections into which the acoustic signal acquired by the acquisition unit 21 has been divided.

In the present embodiment, the Euclidean distances of the first feature amounts in the plurality of sections are compared, and the cosine similarity of the second feature amounts in the plurality of sections is compared. Furthermore, if chord labels indicating chords are applied to the musical piece data MD, the edit distances (Levenshtein distances) of the chord labels in the plurality of sections are compared. The chord labels can be applied to the musical piece data MD using chord analysis. The similarity of the plurality of sections is determined based on the total results of these comparisons.

The classification unit 23 clusters the plurality of sections based on the similarity determined by the determination unit 22. Furthermore, the classification unit 23 passes the clustered acoustic signal to the constituent type estimation unit 30. The classification result output unit 24 displays in a visible manner the result of clustering by the classification unit 23 in the display unit 7. If the results of the clustering need not be displayed in the display unit 7, the section classification unit 20 need not include the classification result output unit 24.

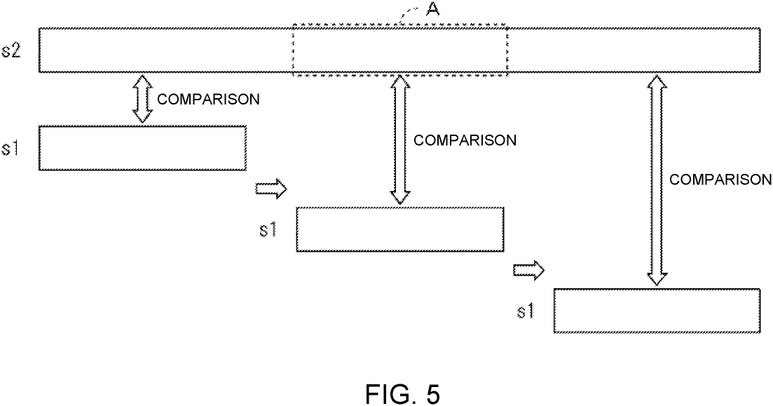

The aforementioned comparison of the plurality of sections, i.e., the comparison of the Euclidean distance, the cosine similarity, and the edit distance, is performed using a maximum value search method. FIG. 5 illustrates the determination of similarity using the maximum value search method. In the example in FIG. 5, the similarity between the section s1 and the section s2 is determined. Here, the section s2 is longer than the section s1. In this case, as the section s1 is shifted from the beginning to the end of the section s2, the similarity between section s1 and each portion of section s2 that has the same size as section s1 is evaluated sequentially.

In the example in FIG. 5, the similarity is greatest between the section s1 and a portion A of section s2. The similarity between the section s1 and the portion A of the section s2 is determined to be the similarity between the section s1 and the section s2. With this determination method, even if there is an error in the identification of the constituent boundary of the musical piece by the section division unit 10, the effect of such an error can be mitigated. Further, if the difference in lengths between two sections being compared is greater than or equal to a prescribed value, a penalty can be introduced to reduce the similarity. Similar sections can thus be clustered more appropriately.

Thus, although a comparison of a plurality of sections is carried out using the maximum value search method in the present embodiment, the present embodiment is not limited thereby. For example, it is also possible to carry out the comparison of the plurality of sections using a dynamic programming method, such as dynamic time warping (DTW).

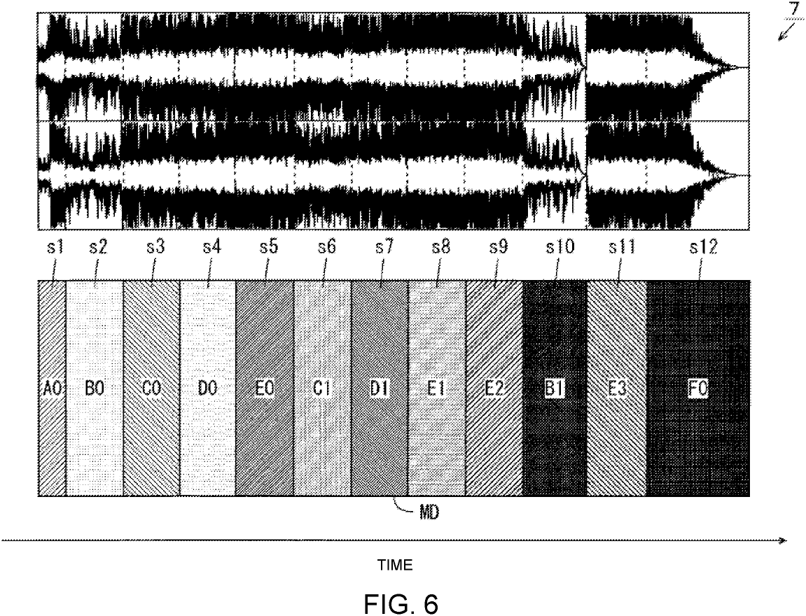

FIG. 6 shows a display example on the display unit 7 by the classification result output unit 24. As shown in FIG. 6, the result of clustering by the classification unit 23 is displayed on the display unit 7 by the classification result output unit 24 as the result of the musical piece structure analysis processing. In the display example in FIG. 6, unique identifiers made up of letters and numbers, such as “A0” or “B0,” etc., are applied to the sections s1 to s12. The letters of identifiers of sections belonging to the same cluster are the same, as in “B0” and “B1,” etc.

The user can easily identify sections belonging to the same cluster by viewing the letters of the identifiers. Moreover, the user can easily determine whether a cluster includes a large or small number of sections by noting the numbers following the letters.

### Constituent Type Estimation Unit

As shown in FIG. 2, the constituent type estimation unit 30 includes an acquisition unit 31, a calculation unit 32, an estimation unit 33, and an estimation result output unit 34. The acquisition unit 31 acquires the clustered acoustic signal from the section division unit 20. The calculation unit 32 calculates for each cluster a score S indicating the likelihood of a specific constituent type portion based on the acoustic signal acquired by the acquisition unit 31.

The estimation unit 33 estimates one or more sections qualifying as (corresponding to) the specific constituent type portion based on the score S calculated by the calculation unit 32. In the present embodiment, the specific constituent type is the first chorus (henceforth referred to as the opening chorus). The estimation result output unit 34 displays in a viewable manner the section estimation results by the estimation unit 33 in the display unit 7. If the section estimation results need not be displayed in the display unit 7, the constituent type estimation unit 30 need not include the estimation result output unit 34.

In the present embodiment, the score S indicating the likelihood of a chorus as the specific constituent type is calculated for each cluster. Here, the chorus of a popular musical piece is assumed to have the following features. A climax frequently occurs, and the power of the acoustic signal is relatively high. Further, the chorus frequently repeats, appearing many times during the musical piece. Also, the starting chord or the ending chord is frequently the tonic chord of the key. In addition, in songs, singing voices (vocals) are often included. Taking these features into consideration, the score S indicating the likelihood of a chorus is represented by expression (1) below.

$$S = {W}_{p} ⋅ {S}_{p} + {W}_{e} ⋅ {S}_{e} + {W}_{n} ⋅ {S}_{u} + {P}_{d}$$

In expression (1), Sₚ is a score indicating the magnitude of the power of the acoustic signal, acquired, for example, as the median of the first feature amount accumulated on each beat and normalized. S_{c} is a score indicating the similarity of the starting chord or ending chord to the tonic chord of the key, and is represented by expression (2) below, for example.

$${S}_{c} = α \left(9.0 - \frac{min \left({S}_{c 1} , {S}_{c 2}\right)}{9.0}\right)$$

In expression (2), α is a coefficient determined based on the number (counted number) of sections belonging to the same cluster, i.e., the number of repetitions of similar sections. The greater the value of the coefficient α, the greater the number of sections. S_{c1} and S_{c2} are scores indicating the similarity of the starting chord and the ending chord to the tonic chord of the key, respectively. Note that min(S_{c1}, S_{c2}) means the lower of score S_{c1} and score S_{c2}.

Each of the scores S_{c1} and S_{c2} is calculated based on the basic space of the total pitch space (TPS). Each of the values of scores S_{c1} and S_{c2} are 0 to 8.5, and the greater the similarity, the smaller the score. Thus, the value of score S_{c1} or score S_{c2} is 0 when the starting chord or the ending chord matches the tonic chord of the key. As disclosed in JP 2020-112683 A, the key can be detected using a learning model generated by learning the relationship between the keys and the time series of specific feature amounts of acoustic signals.

In expression (1), Sᵥ is the average value per beat of the likelihood of vocals being included in the musical piece (henceforth referred to as the vocal likelihood). The vocal likelihood is acquired, for example, by inputting the first feature amount into the third learning model M3 stored in the storage device 5. Wₚ, W_{c}, and Wᵥ are weighting coefficients for the scores Sₚ, S_{c}, and Sᵥ, respectively. P_{d} is a penalty for reducing the score when a section is extremely short. The value of the penalty P_{d} is negative in cases where the length of the section is less than a prescribed value and 0 in cases where the length of the section is greater than or equal to a prescribed value.

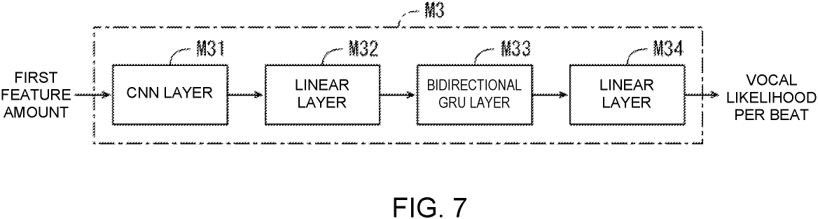

FIG. 7 is a block diagram showing an example of the third learning model M3. As shown in FIG. 7, in the present embodiment, a CNN layer M31, a linear layer M32, a bidirectional GRU layer M33, and a linear layer M34 are arranged in this order in the third learning model M3 from input to output.

A plurality of pieces of musical piece data for learning, in which labels indicating the presence or absence of vocals have been applied, are prepared ahead of time as learning data. In each piece of the learning data, the label “1” is assigned to portions corresponding to beats including vocals, and the label “0” is assigned to portions corresponding to beats not including vocals. The third learning model M3 for outputting the vocal likelihood for each beat is created by carrying out deep learning using the first feature amount extracted from the plurality of pieces of learning data.

The estimation unit 33 selects a cluster qualifying as (corresponding to) the chorus (chorus portion) based on the score S. Furthermore, the estimation unit 33 estimates that the opening section including vocals among sections belonging to the selected cluster is a section qualifying as (corresponding to) the opening chorus.

### Musical Piece Structure Analysis Process

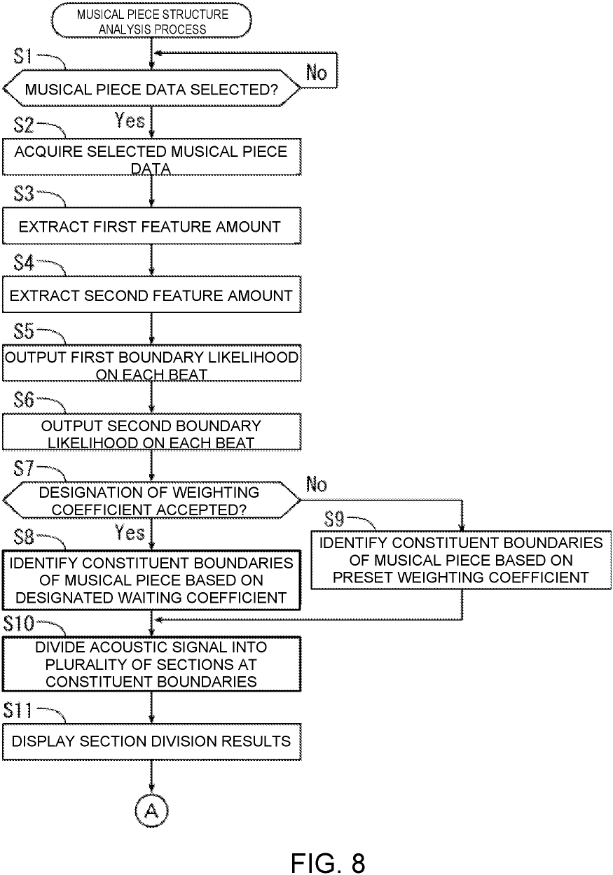

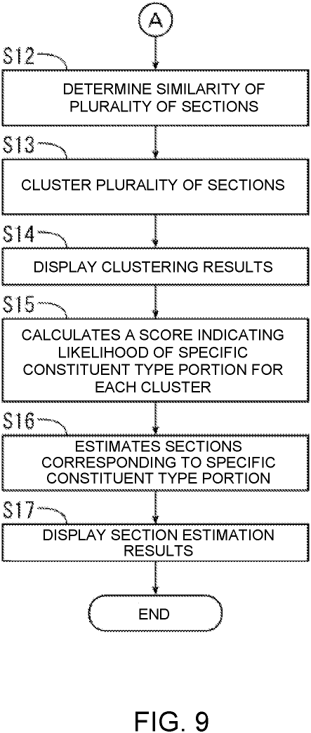

FIGS. 8 and 9 show a flowchart of an example of a musical piece structure analysis process by the musical piece structure analysis device 100 as a computer in FIG. 2. The musical piece structure analysis process in FIGS. 8 and 9 is a structure analysis program which is carried out by the CPU 4 in FIG. 1 executing the musical piece stored in the ROM 3 or the storage device 5.

First, the acquisition unit 11 determines whether the musical piece data MD has been selected based on an operation of the operation unit 6 by the user (Step S1). If the musical piece data MD has not been selected, the acquisition unit 11 stands by until the musical piece data MD is selected. Once the musical piece data MD has been selected, the acquisition unit 11 acquires the selected musical piece data MD from the storage device 5 (Step S2).

The first extraction unit 12 extracts the first feature amount from the acoustic signal of the musical piece data MD acquired in Step S2 (Step S3). The second extraction unit 13 extracts the second feature amount from the acoustic signal of the musical piece data MD acquired in Step S2 (Step S4). Step S3 or Step S4 can be executed first, or both can be executed concurrently.

The first boundary likelihood output unit 14 outputs on each beat the first boundary likelihood based on the first feature amount extracted in Step S3 and the first learning model M1 stored in the storage device 5 (Step S5). The second boundary likelihood output unit 15 outputs on each beat the second boundary likelihood based on the second feature amount extracted in Step S4 and the second learning model M2 stored in the storage device 5 (Step S6). Step S5 or Step S6 can be executed first, or both can be executed concurrently.

The acceptance unit 17 determines whether the designation of a weighting coefficient has been accepted based on operation of the operation unit 6 by the user (Step S7). If designation of a weighting coefficient has been accepted, the identification unit 16 identifies on each beat the constituent boundaries of the musical piece based on the first and second boundary likelihoods output in Steps S5 and S6, respectively, and the designated weighting coefficient (Step S8). If the designation of a weighting coefficient has not been accepted, the identification unit 16 identifies on each beat the constituent boundaries of the musical piece based on the first and second boundary likelihoods output in Steps S5 and S6, respectively, and a preset weighting coefficient (Step S9).

The division unit 18 divides the acoustic signal of the musical piece into a plurality of sections at the constituent boundaries identified in Step S8 or Step S9 (Step S10). The division result output unit 19 displays the section division results of Step S10 in the display unit 7 (Step S11). Step S11 can be omitted.

The determination unit 22 determines the similarity of the plurality of sections divided in Step S10 (Step S12). The classification unit 23 clusters the plurality of sections divided in Step S10 based on the similarity determined in Step S12 (Step S13). The classification result output unit 24 displays results of the clustering in Step S13 (Step S14). Step S14 can be omitted.

The calculation unit 32 calculates the score S indicating the likelihood of a specific constituent type for each cluster based on the acoustic signal in which the plurality of sections have been classified into clusters in Step S13 (Step S15). The estimation unit 33 estimates one or more sections qualifying as (corresponding to) a specific constituent type portion from the plurality of sections based on the score S calculated in Step S15 (Step S16). The estimation result output unit 34 displays section estimation results from Step S16 in the display unit 7 (Step S17) and terminates the musical piece structure analysis process. Step S17 can be omitted.

### Effects of the Embodiment

As described above, the musical piece structure analysis device 100 according to the present embodiment is provided with the acquisition unit 11, which acquires the acoustic signal of the musical piece; the first extraction unit 12, which extracts the first feature amount indicating changes in tone from the acoustic signal of the acquired musical piece; a second extraction unit 13, which extracts the second feature amount indicating changes in chords from the acoustic signal of the acquired musical piece; the first boundary likelihood output unit 14, which outputs the first boundary likelihood indicating the likelihood of a constituent boundary of the musical piece from the first feature amount using the first learning model M1; the second boundary likelihood output unit 15, which outputs the second boundary likelihood indicating the likelihood of a constituent boundary of the musical piece from the second feature amount using the second learning model M2; the identification unit 16, which identifies the constituent boundary of the musical piece by weighted synthesis of the first boundary likelihood and the second boundary likelihood; and the division unit 18, which divides the acoustic signal of the musical piece into a plurality of sections at the identified constituent boundary. The structure of the musical piece can thus easily be carried out.

The musical piece structure analysis device 100 can further be provided with the estimation unit 33, which estimates sections qualifying as the chorus of the musical piece from the plurality of divided sections. In this case, the user can easily identify one or more sections qualifying as the chorus of the musical piece.

The musical piece structure analysis device 100 can further be provided with the acceptance unit 17, which accepts the designation of a weighting coefficient, and the identification unit 16 can perform weighted synthesis of the first boundary likelihood and the second boundary likelihood based on the accepted weighting coefficient. In this case, the weighting coefficient can be changed as appropriate depending on the musical piece.

Further, the musical piece structure analysis device 100 can also be provided with the classification unit 23, which classifies the plurality of sections into clusters based on similarity, and the estimation unit 33 can estimate one or more sections qualifying as a specific constituent type portion of the musical piece from the plurality of divided sections based on the section classification results. In this case, the user can easily identify one or more sections qualifying as the specific constituent type portion of the musical piece.

The musical piece structure analysis device 100 can also be provided with the classification result output unit 24, which outputs in a viewable manner the section classification results. In this case, the user can more easily identify the section classification results.

Furthermore, the musical piece structure analysis device 100 can also be provided with the classification unit 23, which classifies the plurality of divided sections into clusters based on similarity, and the estimation unit 33 can estimate one or more sections qualifying as the chorus of the musical piece from the plurality of sections based on the number (counted number) of one or more sections belonging to each of the classified clusters. In this case, one or more sections qualifying as the chorus of the musical piece can be identified more easily.

Alternately, the musical piece structure analysis device 100 can also be provided with the calculation unit 32, which calculates the score of each section based on at least one of the similarity of the starting chord or the ending chord to the tonic chord of the key in the section of the acoustic signal of the acquired musical piece, or the likelihood of vocals being included in the section, or both, and the estimation unit 33 can estimate one or more sections qualifying as the specific constituent type portion of the musical piece from the plurality of sections based on the calculated score. In this case, one or more sections qualifying as specific constituent type portion of the musical piece can more easily be identified.

### Other Embodiments

(a) In the foregoing embodiment, the constituent boundaries of the musical piece are identified by weighted synthesis of the first boundary likelihood and the second boundary likelihood, but the embodiment is not limited thereby. The constituent boundaries of the musical piece can be identified using another method.

(b) In the foregoing embodiment, the musical piece structure analysis device 100 includes the section division unit 10, but the embodiment is not limited thereby. As long as the acquisition unit 21 can acquire an acoustic signal of a musical piece which has been divided into a plurality of sections, the musical piece structure analysis device 100 need not include the section division unit 10.

(c) In the foregoing embodiment, the estimation unit 33 estimates one or more sections qualifying as the chorus of the musical piece using all of the number of sections belonging to a cluster, the similarity of the opening chord or the ending chord to the tonic chord of the key, and the vocal likelihood, but the embodiment is not limited thereby. The estimation unit 33 can also estimate one or more sections qualifying as the chorus of the musical piece using at least one or more of the number of sections belonging to the cluster, the similarity of the opening chord or the ending chord to the tonic chord of the key, and the vocal likelihood. If the estimation unit 33 estimates one or more sections qualifying as the chorus of the musical piece without using the number of sections belonging to the cluster, the musical piece structure analysis device 100 need not include the section classification unit 20.

(d) In the foregoing embodiment, the estimation section 33 estimates one or more sections qualifying as the chorus of the musical piece from the plurality of sections, but the embodiment is not limited thereby. The estimation section 33 can also estimate one or more sections qualifying as at least one or more different constituent type portions, such as the intro, A melody, B melody, outro, etc., of the musical piece from the plurality of sections.

### Examples Regarding Identification of Constituent Boundaries

In the following examples 1 to 3 and comparison examples 1 to 6, the first and second learning models M1, M2 were generated using a large number of learning data. Musical piece data for evaluation in which labels indicating constituent boundaries of the musical piece were applied was provided as evaluation data. Note that the learning data included 12,593 pieces of labeled Musical Instrument Digital Interface (MIDI) data converted into audio using software and 3,938 sets of labeled MIDI and actual musical pieces. Note that a padding process was carried out on some of the learning data.

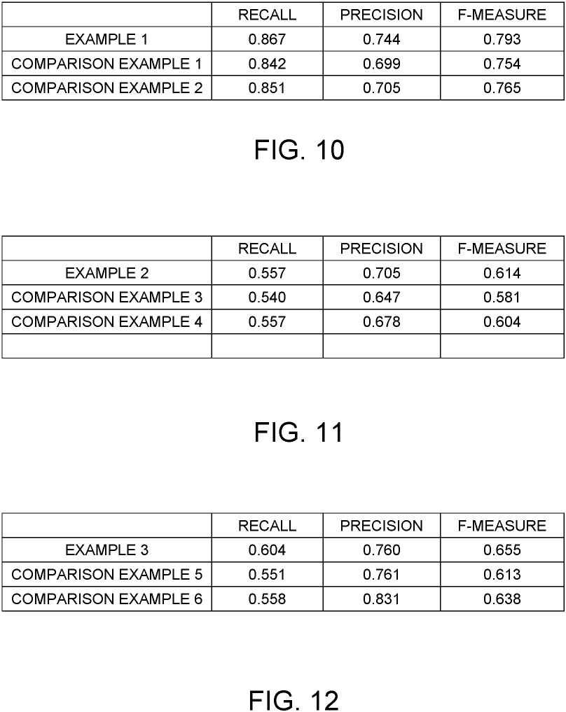

In example 1, the constituent boundaries of the acoustic signal were identified using the first and second learning models M1, M2, with 409 sets of the labeled MIDI data and actual musical pieces used as evaluation data. The weighting coefficient for the first boundary likelihood was 0.4, and the weighting coefficient for the second boundary likelihood was 0.6. Further, the recall, precision, and F-measure of the identified constituent boundaries were evaluated based on the labels in the evaluation data. In comparison examples 1 and 2, only the first and second learning models M1, M2, respectively, were used to identify and evaluate the constituent boundaries as in example 1. FIG. 10 shows evaluation results of example 1 and comparison examples 1 and 2.

In example 2, the same identification and evaluation of constituent boundaries as in example 1 were carried out, except that 100 pieces of musical piece data from a music database for research were used as the evaluation data. In comparison examples 3 and 4, only the first and second learning models M1, M2, respectively, were used to identify and evaluate the constituent boundaries as in example 2. FIG. 11 shows evaluation results of example 2 and comparison examples 3 and 4.

In example 3, the same identification and evaluation of constituent boundaries as in example 2 were carried out, except that 76 pieces of musical piece data in other genres in the music database for research were used as the evaluation data. In comparison examples 5 and 6, only the first and second learning models M1, M2, respectively, were used to identify and evaluate the constituent boundaries as in example 3. FIG. 12 shows evaluation results of example 3 and comparison examples 5 and 6.

The comparison results of examples 1 to 3 and comparison examples 1 to 6 given in FIGS. 10 to 12 confirm that the constituent boundaries of an acoustic signal can be identified with greater overall precision by performing weighted synthesis of the first and second boundary likelihoods than in cases where only the first and second boundary likelihoods are used. On the other hand, depending on the genre of the musical piece, the precision of the identification of the constituent boundaries was confirmed to decrease. Even in these cases, it is thought that a drop in the precision of identification of the constituent boundaries can be prevented by appropriately selecting the weighting coefficients for the first boundary likelihood and the second boundary likelihood in accordance with the genre of the musical piece.

### Examples Regarding Estimation of Constituent Types

In the following examples 4 to 7, the third learning model M3 was created using as the learning data 3,938 pieces of MIDI data to which labels indicating the constituent boundaries of the musical pieces and labels indicating the presence or absence of vocals were applied. Further, musical piece data for evaluation to which the same labels as the learning data were applied was provided as the evaluation data.

In example 4, 200 sets of labeled MIDI data and actual musical pieces were used as the evaluation data. When clustering was not carried out, the correct answer ratios of estimation results for sections qualifying as the opening chorus were evaluated for evaluation data in which vocal likelihood was not used and evaluation data in which vocal likelihood was used. Further, when clustering was carried out, the correct answer ratios of estimation results of sections qualifying as the opening chorus were evaluated in evaluation data in which vocal likelihood was not used and evaluation data in which vocal likelihood was used.

In example 5, the same evaluation as an example 4 was carried out, except that sections qualifying as any chorus were estimated, not just the opening chorus. In example 6, the same evaluation as in example 4 was carried out, except that 100 pieces of musical piece data in the music database for research was used as the evaluation data. In example 7, the same evaluation as in example 6 was carried out except that sections qualifying as any chorus were estimated, not just the opening chorus. Note that the vocal likelihood was acquired using the third learning model M3, and any portions in which 70% or more of the estimated sections was chorus were deemed a correct answer.

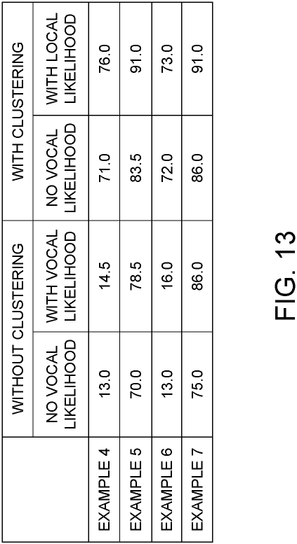

FIG. 13 shows evaluation results for examples 4 to 7. The comparison results of examples 4 to 7 shown in FIG. 13 confirm that the correct answer ratio of the estimation results for sections qualifying as choruses increased by using the vocal likelihood. Further, the correct answer ratio for estimation results of sections qualifying as choruses was confirmed to rise significantly by using clustering.

### Additional Statements

A musical piece structure analysis device according to one aspect of this disclosure comprises at least one processor configured to execute a plurality of units including an acquisition unit, a first extraction unit, a second extraction unit, a first boundary likelihood output unit, a second boundary likelihood output unit, an identification unit, and a division unit. The acquisition unit is configured to acquire an acoustic signal of a musical piece. The first extraction unit is configured to extract a first feature amount indicating changes in tone from the acoustic signal of the musical piece. The second extraction unit is configured to extract a second feature amount indicating changes in chords from the acoustic signal of the musical piece. The first boundary likelihood output unit is configured to output a first boundary likelihood indicating likelihood of a constituent boundary of the musical piece from the first feature amount using a first learning model. The second boundary likelihood output unit is configured to output a second boundary likelihood indicating likelihood of the constituent boundary of the musical piece from the second feature amount using a second learning model. The identification unit is configured to identify the constituent boundary of the musical piece by performing the weighted synthesis of the first boundary likelihood and the second boundary likelihood, The division unit is configured to divide the acoustic signal of the musical piece into a plurality of sections at the constituent boundary.

A musical piece structure analysis device according to another aspect of this disclosure comprises at least one processor configured to execute a plurality of units including an acquisition unit, a division unit, a classification unit, and an estimation unit. The acquisition unit is configured to acquire an acoustic signal of a musical piece. The division unit is configured to divide the acoustic signal of the musical piece into a plurality of sections The classification unit is configured to classify the plurality of sections into clusters based on similarity. The estimation unit is configured to estimate a section qualifying as a specific constituent type portion of the musical piece from the plurality of sections based on classification results of the plurality of sections.

A musical piece structure analysis device according to yet another aspect of this disclosure comprises at least one processor configured to execute a plurality of units including an acquisition unit, a classification unit, and an estimation unit. The acquisition unit is configured to acquire an acoustic signal of a musical piece which has been divided into a plurality of sections. The classification unit is configured to classify the plurality of sections into clusters based on similarity. The estimation unit is configured to estimate a section qualifying as a chorus of the musical piece from the plurality of sections based on a counted number of one or more sections belonging to each of the clusters.

A musical piece structure analysis device according to yet another aspect of this present disclosure comprises at least one processor configured to execute a plurality of units including an acquisition unit, a calculation unit, and an estimation unit. The acquisition unit is configured to acquire an acoustic signal of a musical piece which has been divided into a plurality of sections. The calculation unit is configured to calculate a score for each of the plurality of sections of the acoustic signal of the musical piece, based on at least one or both of similarity of a starting chord or an ending chord in each of the plurality of sections to a tonic chord of a key, or a likelihood of vocals being included in each of the plurality of section. The estimation unit is configured to estimate a section qualifying as a specific constituent type portion of the musical piece from the plurality of sections based on the score that has been calculated for each of the plurality of sections.

By the present disclosure, the structure of musical pieces can easily be analyzed.

What is claimed is:

1. A musical piece structure analysis method executed by a computer, the musical piece structure analysis method comprising:
acquiring an acoustic signal of a musical piece;
extracting a first feature amount indicating changes in tone from the acoustic signal of the musical piece;
extracting a second feature amount indicating changes in chords from the acoustic signal of the musical piece;
outputting a first boundary likelihood indicating likelihood of a constituent boundary of the musical piece from the first feature amount using a first learning model;
outputting a second boundary likelihood indicating likelihood of the constituent boundary of the musical piece from the second feature amount using a second learning model;
identifying the constituent boundary of the musical piece by performing weighted synthesis of the first boundary likelihood and the second boundary likelihood; and
dividing the acoustic signal of the musical piece into a plurality of sections at the constituent boundary that has been identified.

2. The musical piece structure analysis method according to claim 1, further comprising estimating a section qualifying as a chorus of the musical piece from among the plurality of sections.

3. The musical piece structure analysis method according to claim 1, further comprising accepting designation of a weighting coefficient, wherein
the identifying of the constituent boundary of the musical piece is carried out by performing the weighted synthesis of the first boundary likelihood and the second boundary likelihood based on the weighting coefficient.

4. A musical piece structure analysis method executed by a computer, the musical piece structure analysis method comprising:
acquiring an acoustic signal of a musical piece;
dividing the acoustic signal of the musical piece into a plurality of sections;
classifying the plurality of sections into clusters based on similarity; and
estimating a section qualifying as a specific constituent type portion of the musical piece from the plurality of sections based on result of the classifying of the plurality of the sections.

5. The musical piece structure analysis method according to claim 4, further comprising outputting the result of the classifying of the plurality of the sections in a viewable manner.

6. The musical piece structure analysis method according to claim 4, wherein
the specific constituent type portion of the musical piece is a chorus portion of the musical piece.

7. The musical piece structure analysis method according to claim 4, further comprising
extracting a first feature amount indicating changes in tone from the acoustic signal of the musical piece,
extracting a second feature amount indicating changes in chords from the acoustic signal of the musical piece,
outputting a first boundary likelihood indicating likelihood of a constituent boundary of the musical piece from the first feature amount using a first learning model,
outputting a second boundary likelihood indicating likelihood of the constituent boundary of the musical piece from the second feature amount using a second learning model,
accepting designation of a weighting coefficient, and
identifying the constituent boundary of the musical piece by performing weighted synthesis of the first boundary likelihood and the second boundary likelihood based on the weighting coefficient, wherein
the dividing of the acoustic signal of the musical piece into the plurality of sections is performed at the constituent boundary that has been identified.

8. A musical piece structure analysis method executed by a computer, the musical piece structure analysis method comprising:
acquiring a divided acoustic signal of a musical piece that has been divided into a plurality of sections;
classifying the plurality of sections into clusters based on similarity; and
estimating a section qualifying as a chorus of the musical piece from the plurality of sections based on a counted number of one or more sections belonging to each of the clusters.

9. The musical piece structure analysis method according to claim 8, further comprising
acquiring an acoustic signal of the musical piece,
extracting a first feature amount indicating changes in tone from the acoustic signal of the musical piece,
extracting a second feature amount indicating changes in chords from the acoustic signal of the musical piece,
outputting a first boundary likelihood indicating likelihood of a constituent boundary of the musical piece from the first feature amount using a first learning model,
outputting a second boundary likelihood indicating likelihood of the constituent boundary of the musical piece from the second feature amount using a second learning model,
accepting designation of a weighting coefficient,
identifying the constituent boundary of the musical piece by performing weighted synthesis of the first boundary likelihood and the second boundary likelihood based on the weighting coefficient, and
dividing the acoustic signal of the musical piece into the plurality of sections at the constituent boundary that has been identified, to obtain the divided acoustic signal of the musical piece.

10. A musical piece structure analysis method executed by a computer, the musical piece structure analysis method comprising:
acquiring a divided acoustic signal of a musical piece that has been divided into a plurality of sections;
calculating a score for each of the plurality of section of the divided acoustic signal of the musical piece, based on at least one of similarity of a starting chord or an ending chord in each of the plurality of sections to a tonic chord of a key, or a likelihood of vocals being included in each of the plurality of sections, or both; and
estimating a section qualifying as a specific constituent type portion of the musical piece from the plurality of sections based on the score that has been calculated for each of the plurality of sections.

11. The musical piece structure analysis method according to claim 10, wherein
the specific constituent type portion of the musical piece is a chorus portion of the musical piece.

12. The musical piece structure analysis method according to claim 10, further comprising
acquiring an acoustic signal of the musical piece,
extracting a first feature amount indicating changes in tone from the acoustic signal of the musical piece,
extracting a second feature amount indicating changes in chords from the acoustic signal of the musical piece,
outputting a first boundary likelihood indicating likelihood of a constituent boundary of the musical piece from the first feature amount using a first learning model,
outputting a second boundary likelihood indicating likelihood of the constituent boundary of the musical piece from the second feature amount using a second learning model,
accepting designation of a weighting coefficient,
identifying the constituent boundary of the musical piece by performing weighted synthesis of the first boundary likelihood and the second boundary likelihood based on the weighting coefficient, and
dividing the acoustic signal of the musical piece into the plurality of sections at the constituent boundary that has been identified, to obtain the divided acoustic signal of the musical piece.
